(19) United States
(12) Patent Application Publication
(10) Pub. No.: US 2019/0164468 A1
(43) Pub. Date: May 30, 2019

(54) HEAD-MOUNTED DISPLAY DEVICE

(71) Applicant: LG Display Co., Ltd., Seoul (KR)

(72) Inventor: Sang-Hoon JUNG, Goyang-si (KR)

(73) Assignee: LG Display Co., Ltd., Seoul (KR)

(21) Appl. No.: 16/204,771

(22) Filed: Nov. 29, 2018

(30) Foreign Application Priority Data
Nov. 29, 2017 (KR) 10-2017-0162165

(51) Int. Cl. G09G 3/20

(52) U.S. Cl. CPC G09G 3/2092; G09G 2340/0407

(57) ABSTRACT

Disclosed is head-mounted display device including a display panel including a display region in which a plurality of pixels defined by a plurality of data lines and a plurality of gate lines are arranged and a non-display region disposed outside the display region, the display panel including the plurality of data lines disposed between the plurality of pixels adjacent in a first direction and the plurality of gate lines disposed between a plurality of pixels adjacent in a second direction; and a data line part to apply, to a group of one or more wirings disposed in the non-display region and connected to each other, the same signal as a signal applied to the plurality of data lines for transmitting data drive signals to the plurality of pixels of the display region.

### CROSS-REFERENCE TO RELATED APPLICATION

This application claims the benefit of Korean Patent Application No. 10-2017-0162165, filed on Nov. 29, 2017, the entire contents of which is hereby incorporated by reference in its entirety.

### BACKGROUND OF THE INVENTION

### Field of the Invention

The present invention relates to a head-mounted display device, and more particularly, to a head-mounted display device capable of reducing a data addressing time and increasing a driving speed of a display panel, by sharing data lines for providing drive signals to the display panel to apply a foveation rendering algorithm for reducing resolution of a peripheral portion in consideration of resolution.

### Discussion of the Related Art

As various types of displays have emerged, a head-mounted display device mounted on a user's head to view an image is emerging. Such a device is called a head-mounted display (HMD) device. The head-mounted display device is mounted on a part of a body, for example, a head, of a user to display an image implementing virtual reality. Such a head-mounted display device 10 has a goggle shape or a glasses shape, as shown in FIG. 1. A glasses-type head-mounted display device includes a display part 11 for displaying an image and glasses-shaped wearing parts 12 supporting the display part 11 at one side thereof.

Such a head-mounted display device requires ultra-high resolution and high-speed driving in order to realistically implement virtual reality.

### SUMMARY OF THE INVENTION

Accordingly, the embodiments of the present invention are directed to a head-mounted display device that substantially obviates one or more problems due to limitations and disadvantages of the related art.

An object of the embodiments of the present invention is to provide a head-mounted display device capable of implementing ultra-high resolution image quality.

Another object of the embodiments of the present invention is to provide a head-mounted display device capable of increasing a driving speed.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a head-mounted display device is configured such that a data line part and a gate line part of a non-display region are capable of applying the same signals to a plurality of data lines and a plurality of gate lines, respectively, both of which are grouped by region, of a display region.

In the head-mounted display device according to the embodiments of the present invention, the number of data lines and gate lines of the non-display region can be reduced as compared to a conventional display device, thereby achieving high-speed driving.

It is to be understood that both the foregoing general description and the following detailed description of the present invention are by example and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing an example of a goggle-shaped head-mounted display device;

FIGS. 2A and 2B are views showing resolutions of a center part and a peripheral part;

FIG. 3 is a view showing a display panel of a head-mounted display device according to a first embodiment of the present invention;

FIG. 4 is a view showing a display panel of a head-mounted display device according to a second embodiment of the present invention;

FIG. 5A is a view showing arrangement of a gate circuit part of a bezel region in the display device according to the second embodiment of the present invention, and FIG. 5B is a view showing a state of sharing gate lines corresponding to the display panel in the display device shown in FIG. 5A;

FIG. 6A is a view showing a state of sharing gate lines in a display device according to a third embodiment of the present invention, and FIG. 6B is a view showing arrangement of a gate circuit part of a bezel region of the display panel shown in FIG. 6A;

FIG. 7 is a view showing a state of sharing data lines and gate lines for transmitting drive signals of pixels in a head-mounted display device according to another embodiment of the present invention;

FIG. 8 is a view showing the output waveforms of a gate line part in a head mounted display device according to an embodiment of the present invention;

FIG. 9 is a view showing the waveform of a gate signal input to a subpixel in a head-mounted display device according to an embodiment of the present invention;

FIG. 10 is a view showing a state of a data channel when applying a head-mounted display device according to an embodiment of the present invention; and

FIG. 11 is a view showing a display panel according to another embodiment of the present invention.

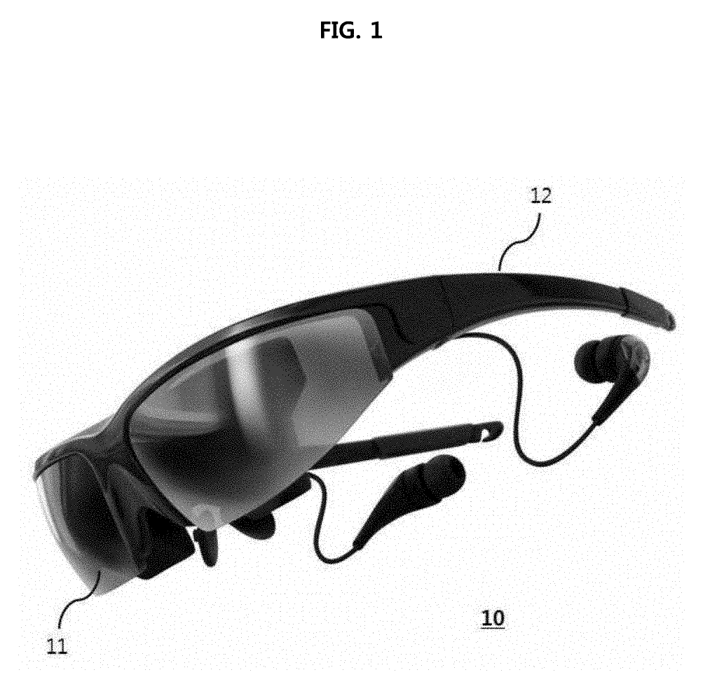

### DETAILED DESCRIPTION OF THE EMBODIMENTS

Specific structures or functions are described for the purpose of explaining the embodiments of the present invention and the embodiments of the present invention may be implemented in a variety of forms and should not be limited to the embodiments disclosed herein.

Since the present invention may be variously modified and have several example embodiments, example embodiments will be shown in the accompanying drawings and described in detail. However, it is to be understood that the present invention is not limited to the example embodiments, but includes all modifications, equivalents, and substitutions included within the spirit and the scope of the present invention.

Terms such as ‘first’, ‘second’, etc., may be used to describe various components, but the components are not to be construed as being limited to the terms. The terms are used only to distinguish one component from another component. For example, the ‘first’ component may be named the ‘second’ component and the ‘second’ component may also be similarly named the ‘first’ component, without departing from the scope of the embodiments of the present invention.

It is to be understood that when one element is referred to as being “connected to” or “coupled to” another element, it may be connected directly to or coupled directly to another element or be connected to or coupled to another element, having the other element intervening therebetween. On the other hand, it is to be understood that when one element is referred to as being “connected directly to” or “coupled directly to” another element, it may be connected to or coupled to another element without the other element intervening therebetween. Other expressions describing a relationship between components, that is, “between,” “directly between,” “neighboring,” “directly neighboring” and the like, should be similarly interpreted.

Terms used in the present specification are used only in order to describe example embodiments rather than limiting the present invention. Singular forms used herein are intended to include plural forms unless explicitly indicated otherwise. It will be further understood that the terms “comprises” or “have” used in this specification, specify the presence of stated features, steps, operations, components, parts, or a combination thereof, but do not preclude the presence or addition of one or more other features, numerals, steps, operations, components, parts, or combinations thereof.

Unless indicated otherwise, it is to be understood that all the terms used in the specification including technical and scientific terms have the same meaning as understood by those skilled in the art. It must be understood that the terms defined by the dictionary are identical with the meanings within the context of the related art, and they should not be ideally or excessively formally defined unless context clearly dictates otherwise.

On the other hand, if an embodiment is otherwise implemented, the functions or operations specified in particular blocks may be performed in an order different from the order specified in the flowchart. For example, two consecutive blocks may actually be performed substantially concurrently, and the blocks may be performed backwards depending on the associated function or operation.

Hereinafter, example embodiments of the present invention will be described in detail with reference to the accompanying drawings.

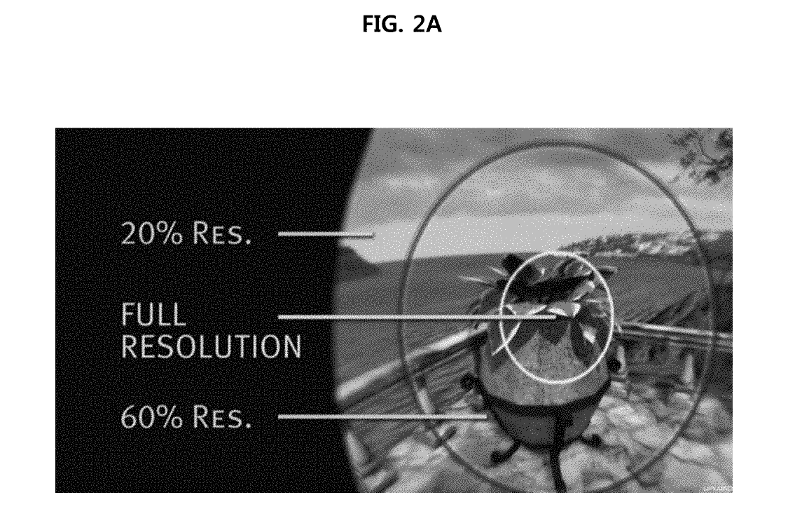

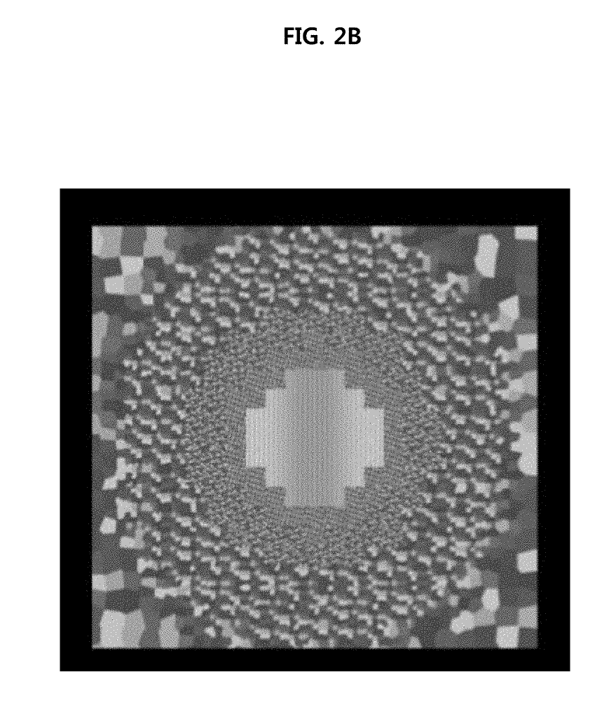

As shown in FIG. 2A, the human eye has high resolution only in a gaze part. That is, a part of a field of view corresponding to a front center (or a center part) of the field of view has full resolution, a surrounding part surrounding the center part has resolution of about 60%, and a peripheral part of the field of view has resolution of about 20%. That is, as shown in FIG. 2B, it can be seen that a resolution can be gradually or stepwise decreased from the center part to the peripheral part. In embodiments of the present invention, each of the surrounding part and the peripheral part may be annular about the center part, or concentric, but such is not required, and the surround part and the peripheral part can simply be farther from the center part from each other.

In consideration of this, a head-mounted display device can use a foveation rendering algorithm for decreasing a data processing and communication speed by implementing different resolutions according to field of view.

The foveation rendering algorithm can be a technique for reducing a virtual reality rendering load by realistically reproducing an image in the field of view of human eyes of about 210° to 230°. That is, this can be a technique for differently setting the data processing speeds of a center part having high resolution and a peripheral part having low resolution in order to reduce resolution of a part other than the center part of an image according to field of view to reduce a rendering load.

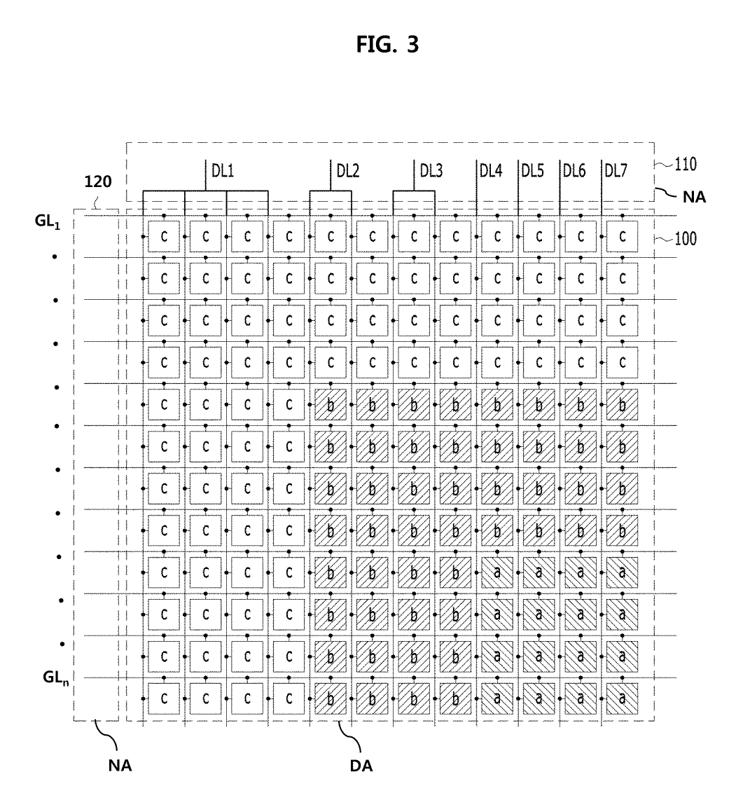

FIG. 3 is a view showing a display panel 100 of a head-mounted display device according to a first embodiment of the present invention. All the components of the head-mounted display device according to all embodiments are operationally coupled and configured. For description, a plurality of pixels a, b, c, gate lines GL or GL1 to GLn for transmitting gate drive signals through the x-axis pixels, and data lines DL or DL1 to DL7 for transmitting data drive signals through the y-axis pixels are schematically shown, though the numbers, sizes or positions of which are representations and not necessarily set and can vary. The embodiment of the present invention provides a head-mounted display device capable of reducing a data driving speed and a data communication amount by applying a foveation rendering algorithm. Accordingly, as shown in FIG. 3, a display panel can be divided into a plurality of virtual regions in order to apply the foveation rendering algorithm. That is, the entire region of the display panel can be divided into a region A having pixels a, at which a user who wears a head-mounted display device gazes, as a high-resolution region, a region B having pixels b as a middle-resolution region, and a region C having pixels c as a low-resolution region. Such a division algorithm can be performed by a timing controller for data drive signals and gate drive signals for driving pixels forming the display panel 100. That is, the display panel 100 used in a display region DA can be a display panel for a general head-mounted display device, and a data line part 110 for applying, to a group of one or more wirings (e.g., DL1 to DL7) connected to each other, the same signal as a signal applied to a plurality of data lines for transmitting the data drive signals to the pixels of the display region can included in a non-display region NA. At this time, each of the gate lines (e.g., GL1 to GLn) of the gate line part 120 can be connected to the pixels on one x-axis line. In the low-resolution region C forming the display panel, since the number of pixels for outputting the same image can be largest, the region occupied by the pixels for the same image can be largest. In contrast, in the high-resolution region A, since high resolution should be implemented, the region occupied by the pixels for outputting the same image can be smallest. The number of connected data lines may be determined based on the high-resolution region A having highest resolution according to the gaze of the user who wears the head-mounted display device. At this time, on the x axis, the area of the pixels for receiving the same drive signals can be widest in the low-resolution region C and the area in which the same drive signal can be received can be reduced in order of the middle-resolution region B and the high-resolution region A. Meanwhile, on the y axis, upper and lower regions occupy the same area. At this time, according to resolution, the sizes of areas occupied by the pixels, which can be driven by the same signal, of the low-resolution region C, the middle-resolution region B and the high-resolution region A differ from each other by a plurality of times. In the present embodiment, a ratio of 4:2:1 is shown. However, this is but one example embodiment and the ratio is not limited thereto.

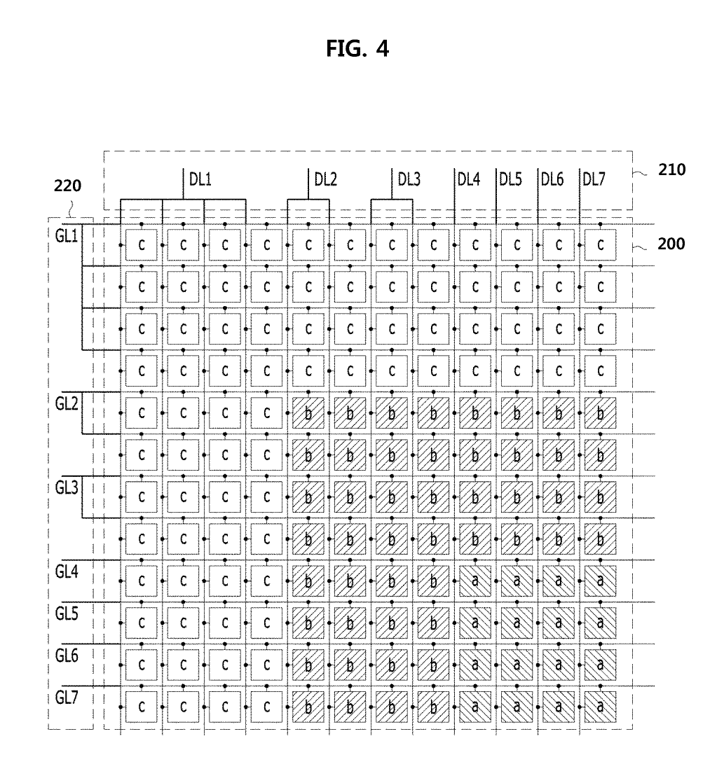

FIG. 4 is a view showing a display panel of a head-mounted display device according to a second embodiment of the present invention. Unlike the first embodiment, as shown in FIG. 3, a plurality of pixels (e.g., a, c and c) can be arranged in a panel part 200 which can be a display region for substantially displaying an image, and a data line part 210 and a gate line part 220 respectively including data lines DL1 to DL7 and gate lines GL1 to GL7 for transmitting drive signals for driving the pixels can be included in a non-display region NA (e.g., parts other than the display region of the display panel 200, and which includes the gate line part 220). Unlike the first embodiment, a gate line part 220 for applying, to wirings connected to each other, the same signal as signals applied to the plurality of gate lines of the display region can be further included in the non-display region. The data drive signal applied to each subpixel can be transmitted through the y-axis data line and the gate drive signal applied to each subpixel can be transmitted through the x-axis gate line.

In order to implement the low-resolution region C, plural pixels share one data line. For example, four pixel wirings may share one data line. Although four pixel wirings share one data line in the following description, the embodiment of the present invention is not limited thereto. In order to implement the middle-resolution region B, a plurality of pixels share one data line. For example, two pixels may share one data line. Although two pixels share one data line in the following description, the embodiment of the present invention is not limited thereto. In embodiments of the present invention, amounts of the plurality of pixels that are connected to a plurality of data lines in a first direction and a plurality of gate lines in a second direction can be different based on locations of the plurality of pixels in the display region of the display panel 200.

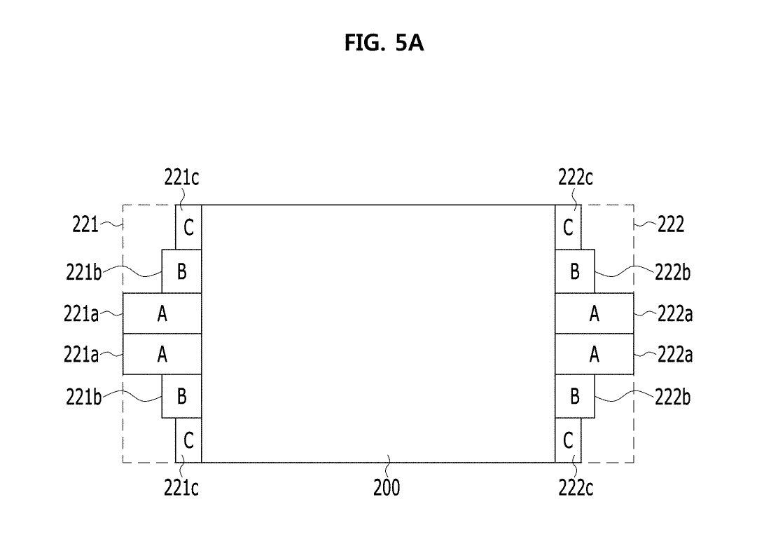

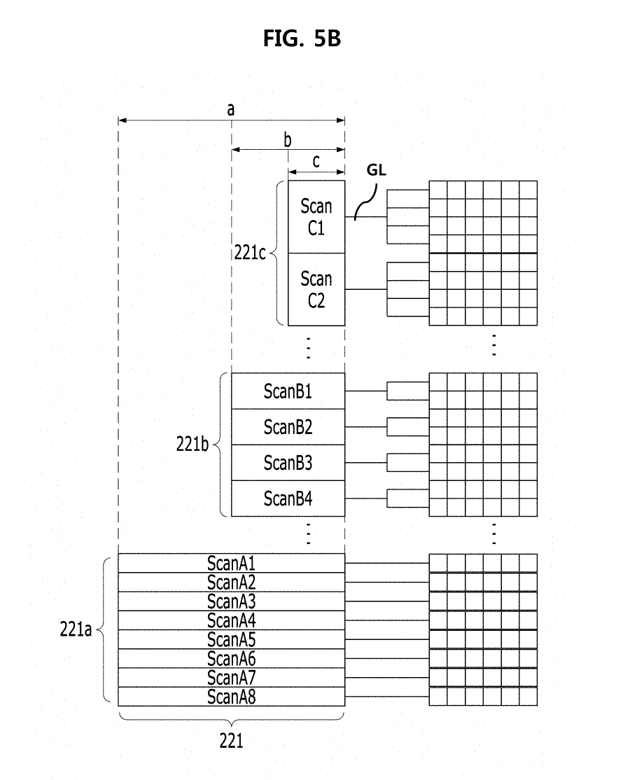

FIG. 5A is a view showing arrangement of a gate circuit part of a bezel region in the display device according to the second embodiment of the present invention. As shown in the figure, the sizes of the gate line circuits included in the gate line part disposed in a left bezel region 221 and a right bezel region 222 of a display panel 200 may differ according to resolution to be implemented. That is, the sizes of the gate line circuits of the regions 221c and 222c corresponding to the low-resolution region can be smallest, the sizes of the gate line circuits of the regions 221a and 222a corresponding to the high-resolution region can be largest, and the sizes of the gate line circuits of the regions 221b and 222b corresponding to the middle-resolution region can be in the middle.

FIG. 5B is a view showing a state of sharing gate lines corresponding to the display panel in the display device shown in FIG. 5A.

As described above, a gate line GL may be shared similarly to sharing the data line. That is, gate signals scanC1, scanC2, . . . may be transmitted to pixels on four x-axes through a shared gate wiring in the low-resolution region C corresponding to the peripheral part of the field of view, gate signals scanB1, scanB2, scanB3, scanB4 . . . may be transmitted to pixels on two x-axes through a shared gate wiring in the middle-resolution region B, and gate signals scanA1, scanA2, scanA8 may be transmitted to pixels on each x-axis in one-to-one correspondence in the high-resolution region A. By example, region C pixels can be shared via three gate wirings, region B pixels can be shared via two gate wirings and region A pixels do not share gate wirings, but the number of the shared gate wirings can vary.

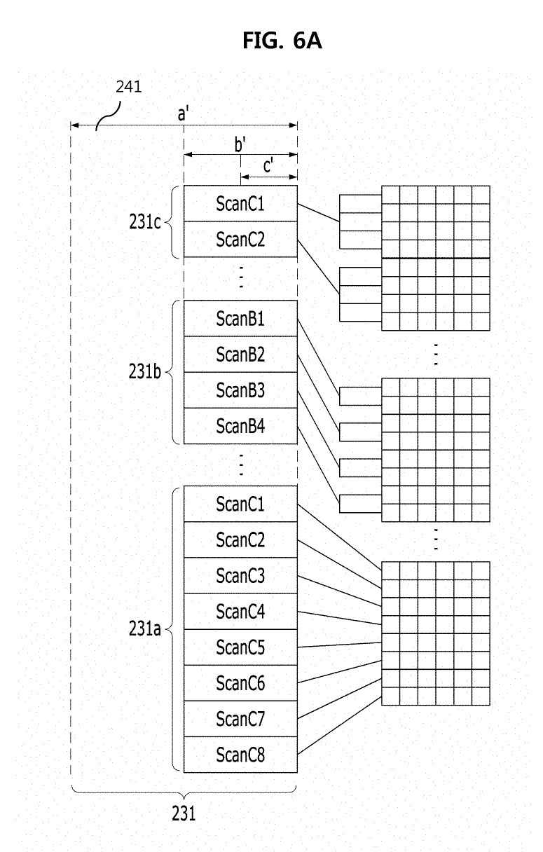

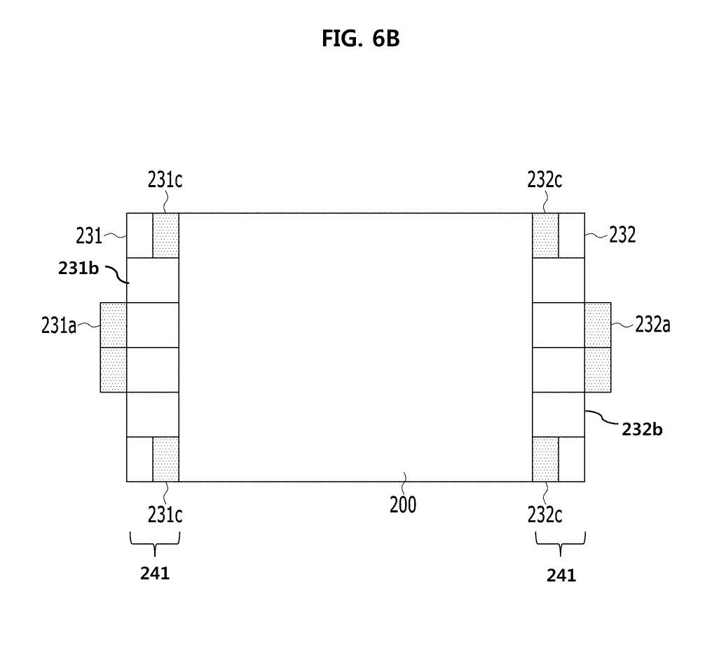

FIG. 6A is a view showing a state of sharing gate lines in a display device according to a third embodiment of the present invention, and FIG. 6B is a view showing arrangement of a gate circuit part of a bezel region of the display panel shown in FIG. 6A.

As shown in FIG. 6A, the widths of the gate circuit part regions 231a, 231b and 231c provided in a bezel 241 may become equal by sharing the gate line. By sharing the area of the gate line circuit reduced by sharing of the gate line, it is possible to implement a size corresponding to the average size of the gate circuit wirings a, b and c. That is, as shown in FIG. 5A, a space can be left beside the gate circuit part region 221c of the non-display region corresponding to the low-resolution region of the display region as compared to the gate circuit part region 221a of the non-display region corresponding to the high-resolution region of the display region. As shown in FIG. 6A, in order for the regions 231a, 231b and 231c forming the gate circuit part 231 of the non-display region to have the same width, the gate circuit part of the non-display region corresponding to the middle-resolution region of the display region may be disposed in the remaining space of the gate circuit part of the non-display region corresponding to the middle-resolution region of the display region. At this time, the region 231a of the gate circuit part 231 of the non-display region corresponding to the high-resolution region of the display region may be reduced as compared to the region 221a of the gate circuit part 231 of the non-display region of FIGS. 5A and 5B.

The region of the gate circuit part 231 of the non-display region shares the area reduced through wiring sharing in the gate circuit part region of low resolution and thus has a size corresponding to the average size of the high-resolution region A, the middle-resolution region B and the low-resolution region C. If the size of the region of the gate circuit part corresponding to the middle-resolution region B corresponds to the average size of the high-resolution region A, the middle-resolution region B and the low-resolution region C, the total width of the gate line circuit part 231 may be equal to the size of the middle-resolution circuit part region 231b. Accordingly, the total size of the bezel 241 in which different gate line circuits may be disposed may be reduced through sharing of the gate line GL. As shown in FIG. 6B, the right side of the display panel 200 can include another bezel 241 having regions 232, 232a, 232b, 232c.

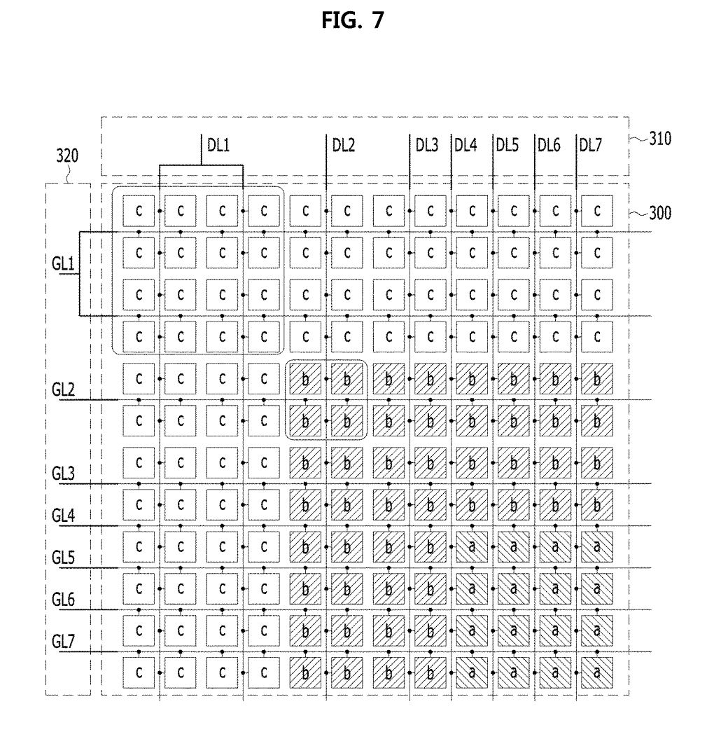

FIG. 7 is a view showing a state of sharing data lines and gate lines for transmitting drive signals of pixels in a head-mounted display device according to another embodiment of the present invention.

Meanwhile, as shown in FIG. 7, one data line and one gate line can be connected to and shared between two neighboring pixels. The data line (e.g., at least one of DL1 to DL7) of a data line part 310 connected to the subpixel parts of the low-resolution region C and the middle-resolution region B can be shared between and connected to the left and right pixels (c and b) relative to the data line. However, one data line (e.g., at least one of DL4 to DL7) can be connected to the subpixel part of the high-resolution region A. That is, the gate line (e.g., at least one of GL1 to GL7) of a gate line part 320 of the low-resolution region C and the middle-resolution region B of the non-display region can be shared between and connected to the upper and lower pixels (c and b) relative to the gate line, and the gate line (e.g., at least one of GL4 to GL7) of the high-resolution region A of the non-display region 300 can be connected to one subpixel of the display region 300. At this time, neither a data line DL nor a gate line GL may be disposed between some pixels c.

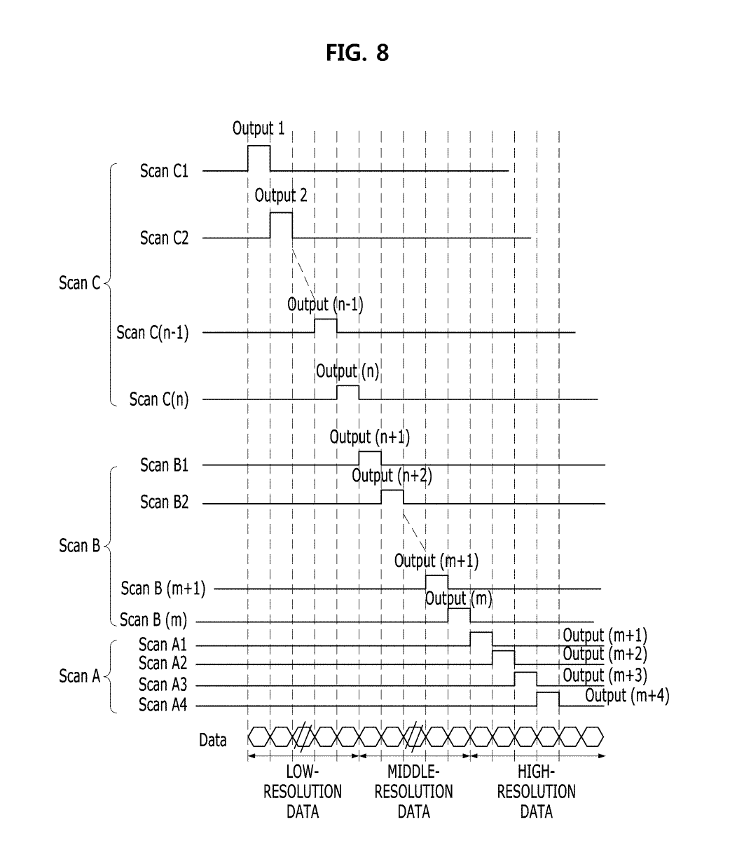

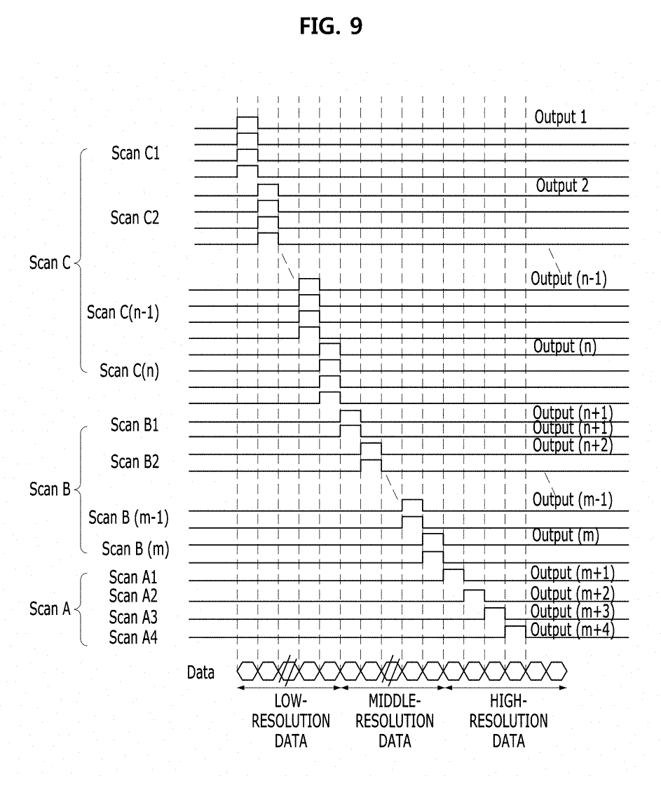

FIG. 8 is a view showing the output waveforms of a gate line part in a head mounted display device according to an embodiment of the present invention, and FIG. 9 is a view showing the waveform of a gate signal input to a subpixel in a head-mounted display device according to an embodiment of the present invention.

In the embodiment of the present invention, since the data line DL and the gate line GL can be shared between the pixels of the low-resolution region C and the middle-resolution region D, timing for driving each subpixel may be equal to conventional scanning timing. That is, the output waveform of the gate line GL may not be a specific waveform.

As shown in FIG. 8, if it is assumed that the number of gate lines for transmitting the gate signals in the low-resolution region C is “n”, it may be assumed that a first gate line for transmitting the gate signal in the middle-resolution region B is “n+l” and, if it is assumed that the number of wirings for transmitting the gate signal in the low-resolution region C and the middle-resolution region B is “m”, it may be assumed that the first wiring for transmitting the gate signal in the high-resolution region A is “m+1”.

At this time, the gate signals transmitted through the gate lines can be sequentially output as shown in FIG. 8. In contrast, as shown in FIG. 9, the gate signal applied to the low-resolution region C of the display panel may be commonly transmitted to multiple wirings, such as four wirings at the same time, for example, the gate signal applied to the middle-resolution region B may be commonly transmitted to multiple gate lines, such as two gate lines at the same time, and the gate signal applied to the high-resolution region A may be transmitted individually to each line and to each subpixel.

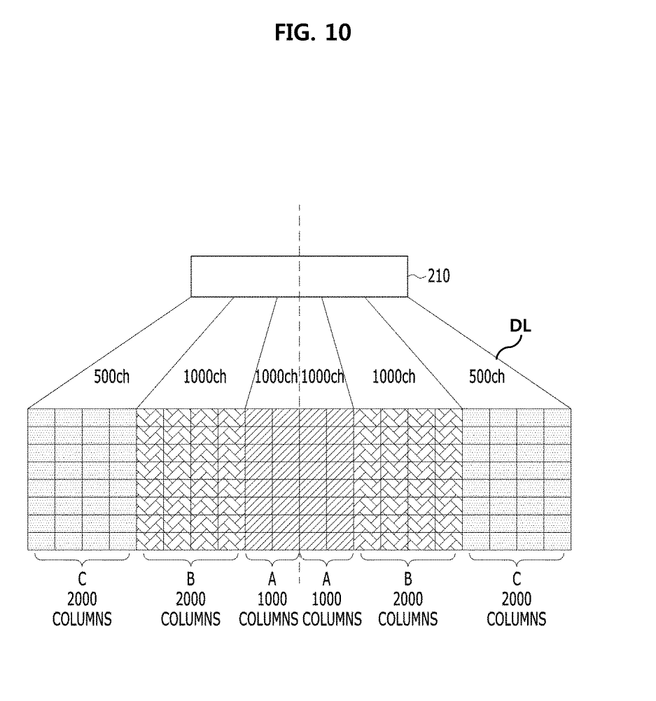

FIG. 10 is a view showing a state of a data channel when applying a head-mounted display device according to an embodiment of the present invention.

FIG. 10 shows the state of a data channel upon applying the head-mounted display device according to an embodiment of the present invention. For example, assume that 2000 columns of pixels can be arranged in the low-resolution region C and the middle-resolution region B and 1000 columns of pixels can be arranged in the high-resolution region A, thereby including 10,000 columns of pixels. Data lines of 500 channels can be connected in the low-resolution region C. That is, each of the data lines in the low-resolution region C can be shared between and connected to four columns. Accordingly, the data signals may be transmitted to 2000 columns of pixels in the low-resolution region C through the data lines of 500 channels. Each of the data lines in the middle-resolution region B can be shared between and connected to two columns. Accordingly, the data signals may be transmitted to 2,000 columns of pixels in the middle-resolution region C through the data lines of 1000 channels. In contrast, in the high-resolution region A, the data line can be connected to one column of pixels and 1,000 channels can be disposed in each of the left and right regions. Accordingly, the data lines 240 of 5,000 channels can be connected to the display panel 200 having 10,000 columns of pixels and the number of data lines can be reduced as compared to the conventional display device, which can be advantageous for high-speed driving. The embodiments of the present invention are not limited thereto.

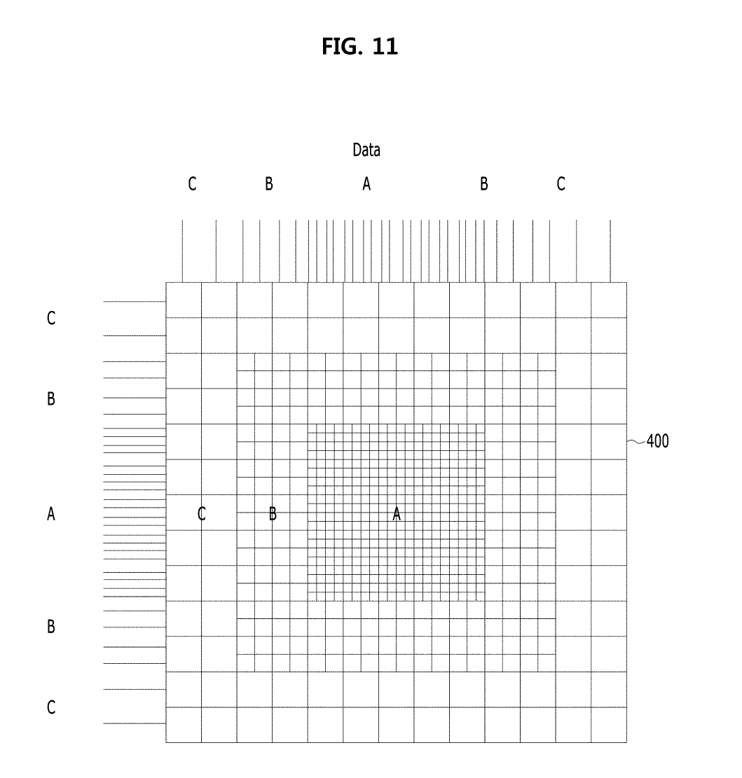

FIG. 11 is a view showing a display panel 400 according to another embodiment of the present invention. Unlike a display panel used in a general head-mounted display device, the sizes of pixels configuring the display panel may be changed according to resolution. It can be seen that the size of the pixels in the low-resolution region C configuring a display pixel part can be largest and the size of the pixels in the high-resolution region A can be smallest. Accordingly, in the data line part and the gate line part of the non-display region, the numbers of data lines and the gate lines correspond to the numbers of pixels included in the regions A, B and C of the display region. That is, the number of data lines corresponding to the low-resolution region C can be smallest and the number of data lines corresponding to the high-resolution region A can be largest. The embodiments of the present invention are not limited thereto.

Although the ratio of the sizes of the pixels of the low-resolution region C, the middle-resolution region B and the high-resolution region A configuring the display pixel part can be 4:2:1, the embodiment of the present invention is not limited thereto.

The configurations of the data line part and the gate line part in the non-display region of the display device according to the embodiment of the present invention may be designed based on the subpixel part of a highest-resolution display region. At this time, the data lines for driving the subpixel part of the low-resolution region C can be arranged such that a plurality (e.g., four) of pixels can be simultaneously driven by one data line, the data lines for driving the subpixel part of the middle-resolution region B can be arranged such that a plurality of (e.g., two) of pixels can be simultaneously driven by one data line, and the data lines for driving the subpixel part of the high-resolution region A can be arranged such that one subpixel can be driven by one data line. Similarly, a plurality (e.g., four) of pixels can be connected to one gate line in the gate lines for transmitting the gate signals to the subpixel part of the low-resolution region C, a plurality (e.g., two) of pixels can be connected to one gate line in the gate lines for transmitting the gate signals of the subpixel part of the middle-resolution region B, and one subpixel can be connected to one gate line in the gate lines for transmitting the gate signals of the subpixel part of the high-resolution region A. The embodiments of the present invention are not limited thereto.

In the embodiment of the present invention, drive signals may be applied to the plurality of data lines and/or the gate lines of the display region through a group of data lines and/or gate lines connected to each other in the non-display region. Accordingly, upon driving one frame, the number of data lines and gate lines of the non-display region for transmitting the drive signals may be reduced, thereby achieving high-speed driving. Meanwhile, if a driving frequency is fixed, the number of lines for driving the pixels during the same time may be increased, thereby implementing high resolution. In addition, since a plurality of data lines or gate lines of the non-display region can be grouped to provide the same signal, power consumption can be reduced.

The head-mounted display device according to the embodiment of the present invention may have the following effects.

First, since data can be efficiently processed in a panel using a foveation rendering algorithm, it can be possible to reduce a data processing time.

Second, since the data processing time can be reduced, it can be possible to increase the driving speed of a display panel.

Third, it can be possible to implement ultra-high resolution image quality.

Although the invention has been described with reference to the example embodiments, those skilled in the art will appreciate that various modifications and variations can be made in the embodiments of the present invention without departing from the spirit or scope of the invention described in the appended claims.

What is claimed is:

1. A head-mounted display device comprising:
a display panel including a display region in which a plurality of pixels defined by a plurality of data lines and a plurality of gate lines are arranged and a non-display region disposed outside the display region, the display panel including the plurality of data lines disposed between the plurality of pixels adjacent in a first direction and the plurality of gate lines disposed between a plurality of pixels adjacent in a second direction; and
a data line part to apply, to a group of one or more wirings disposed in the non-display region and connected to each other, the same signal as a signal applied to the plurality of data lines for transmitting data drive signals to the plurality of pixels of the display region.

2. The head-mounted display device according to claim 1, wherein the display region includes a high-resolution region disposed at a center part of the display panel having high resolution and a low-resolution region disposed outside the high-resolution region having lower resolution compared to the high-resolution region.

3. The head-mounted display device according to claim 2, wherein sizes of the plurality of pixels in a y-axis direction are equal, sizes of x-axis pixels in the low-resolution region are largest, and sizes of x-axis pixels in the high-resolution region are smallest.

4. The head-mounted display device according to claim 2, further comprising a gate line part in the non-display region to apply, to a group of wirings connected to each other, the same signal as a signal input to the plurality of gate lines of the display region.

5. The head-mounted display device according to claim 4, wherein a data line and a gate line of the display region, to which the same data line drive signal and the same gate line drive signal are sequentially applied, are located in the low-resolution region of the display region.

6. The head-mounted display device according to claim 4, wherein a size of a gate line part region corresponding to the low-resolution region of the display region is smallest and a size of a gate line part region corresponding to the high-resolution region of the display region is largest.

7. The head-mounted display device according to claim 4, wherein a size of pixels in the low-resolution region forming the display panel is largest and a size of pixels in the high-resolution region is smallest.

8. The head-mounted display device according to claim 4, wherein a region of the gate line part of non-display region has a size corresponding to an average size of the high-resolution region, a middle-resolution region, and the low-resolution region, by sharing an area reduced through sharing of gate lines having low resolution of the display region.

9. The head-mounted display device according to claim 4, wherein a plurality of wirings of the data line part and the gate line part of the low-resolution region of the non-display region are configured to be connected.

10. The head-mounted display device according to claim 4, wherein one data line and one gate line are connected to two adjacent pixels of the display panel.

11. The head-mounted display device according to claim 10, wherein neither a data line nor a gate line is arranged between adjacent pixels in a portion of the display panel.

12. A head-mounted display device comprising:
a display panel including a display region in which a plurality of pixels defined by a plurality of data lines in a first direction and a plurality of gate lines in a second direction are arranged and a non-display region disposed outside the display region,
wherein amounts of the plurality of pixels that are connected to the plurality of data lines in the first direction and the plurality of gate lines in a second direction are different based on the location of the plurality of pixels in the display region of the display panel.

13. The head-mounted display device according to claim 12, further comprising a data line part to apply, to a group of one or more wirings disposed in the non-display region and connected to each other, the same signal as a signal applied to the plurality of data lines for transmitting data drive signals to the plurality of pixels of the display region.

14. The head-mounted display device according to claim 12, wherein the display region includes a high-resolution region disposed at a center part of the display panel having high resolution and a low-resolution region disposed outside the high-resolution region having lower resolution compared to the high-resolution region.

15. The head-mounted display device according to claim 14, wherein sizes of x-axis pixels in the low-resolution region are largest, and sizes of x-axis pixels in the high-resolution region are smallest.

16. The head-mounted display device according to claim 14, further comprising a gate line part in the non-display region to apply, to a group of wirings connected to each other, the same signal as a signal input to the plurality of gate lines of the display region.

17. The head-mounted display device according to claim 16, wherein a data line and a gate line of the display region, to which the same data line drive signal and the same gate line drive signal are sequentially applied, are located in the low-resolution region of the display region.

18. The head-mounted display device according to claim 16, wherein a size of a gate line part region corresponding to the low-resolution region of the display region is smallest and a size of a gate line part region corresponding to the high-resolution region of the display region is largest.

19. The head-mounted display device according to claim 16, wherein a size of pixels in the low-resolution region forming the display panel is largest and a size of pixels in the high-resolution region is smallest.

20. The head-mounted display device according to claim 12, wherein none of the plurality of data lines and the plurality of gate lines is arranged between adjacent pixels in a portion of the display panel.
